(19) United States
(12) Patent Application Publication
(10) Pub. No.: US 2013/0214970 A1
(43) Pub. Date: Aug. 22, 2013

(54) APPARATUS AND METHOD FOR ENHANCING WIRELESS MESH NETWORK COMMUNICATIONS

(71) Applicants: Robert Paul Stachow, Carson City, NV (US); Brandon James Rank, Minden, NV (US); Trevor Shaun Kavanaugh, Minden, NV (US)

(72) Inventors: Robert Paul Stachow, Carson City, NV (US); Brandon James Rank, Minden, NV (US); Trevor Shaun Kavanaugh, Minden, NV (US)

(21) Appl. No.: 13/401,531

(22) Filed: Feb. 21, 2012

(51) Int. Cl. H01Q 3/00

(52) U.S. Cl. 342/359

(57) ABSTRACT

A wireless mesh network includes a first network node including a first antenna positioned in a first orientation, a first processor, and a first orientation sensor. The first processor is programmed to determine the first orientation using the first orientation sensor and to transmit, using the first antenna, the first orientation to a computing device. The network also includes a second network node including a second antenna positioned in a second orientation, a second processor, and a second orientation sensor. The second processor is programmed to determine the second orientation using the second orientation sensor and to transmit, using the second antenna, the second orientation to the computing device for use in comparing the first orientation with the second orientation.

### BACKGROUND OF THE INVENTION

The embodiments described herein relate generally to wireless communications and, more particularly, to methods and apparatus for enhancing communications transmitted via wireless mesh networks.

Many known communications networks are configured as wireless mesh networks (WMNs). Such WMNs include a plurality of radio nodes organized in a mesh topology. At least some known WMNs are wireless broadband networks, sometimes referred to as Wi-Fi networks, that use the Institute of Electrical and Electronics Engineers (IEEE) standard 802.16™. Such Wi-Fi networks may transmit large volumes of information in excess of 10 Megabits per second (Mbits/sec) and operate in frequency ranges in excess of 2.4 GigaHertz (GHz). Also, such Wi-Fi networks use omnidirectional antennas, directional antennas, or a combination thereof, and are known to have a relatively high rate of power consumption, e.g., in excess of 400 milliamperes (mA) per network device.

In addition, at least some known WMNs use either the ZigBee® specification or the WirelessHART™ standard, as both are based on the IEEE standard 802.15.4™ for low-rate wireless networks. Such low-rate wireless networks generally transmit relatively small volumes of information, e.g., approximately 250 Kilobits per second (Kbits/sec) or less. Moreover, such low-rate wireless networks operate with frequencies of approximately 2.4 GigaHertz (GHz) or less. Also, such low-rate wireless networks have a relatively low rate of power consumption as compared to the Wi-Fi networks, e.g., less than 50 mA per device.

Low-rate wireless networks are generally less complex, cost-effective substitutes for the more expensive Wi-Fi networks, and are generally used in industrial facilities where network traffic is typically limited to sensor information. Known low-rate wireless networks use omnidirectional antennas that typically produce a toroidal radiation pattern, requiring antennas to be oriented in a substantially parallel arrangement for optimum communication. Accordingly, an apparatus and method for determining the orientation of antennas in a wireless mesh network is needed in order to enhance communications transmitted via the wireless mesh network.

### BRIEF DESCRIPTION OF THE INVENTION

In one aspect, a wireless mesh network is provided. The wireless mesh network includes a first network node including a first antenna positioned in a first orientation, a first processor, and a first orientation sensor. The first processor is programmed to determine the first orientation using the first orientation sensor and to transmit, using the first antenna, the first orientation to a computing device. The network also includes a Second network node including a second antenna positioned in a second orientation, a second processor, and a second orientation sensor. The second processor is programmed to determine the second orientation using the second orientation sensor and to transmit, using the second antenna, the second orientation to the computing device for use in comparing the first orientation with the second orientation.

In another aspect, a monitoring system is provided. The system includes at least one monitoring sensor, at least one computing device, and a wireless mesh network. The wireless mesh network includes a first network node including a first antenna positioned in a first orientation, a first processor, and a first orientation sensor. The first processor is programmed to determine the first orientation using the first orientation sensor and to transmit, using the first antenna, the first orientation to a computing device. The network also includes a second network node including a second antenna positioned in a second orientation, a second processor, and a second orientation sensor. The second processor is programmed to determine the second orientation using the second orientation sensor and to transmit, using the second antenna, the second orientation to the computing device for use in comparing the first orientation with the second orientation.

In yet another aspect, a method of operating a network is provided. The method includes providing a first network node having a first antenna positioned in a first orientation, a first processor, and a first orientation sensor, determining, using the first processor, the first orientation using the first orientation sensor, providing a second network node having a second antenna positioned in a second orientation, a second processor, and a second orientation sensor, determining, using the second processor, the second orientation using the second orientation sensor, and comparing the first orientation with the second orientation.

### BRIEF DESCRIPTION OF THE DRAWINGS

The embodiments described herein may be better understood by referring to the following description in conjunction with the accompanying drawings.

FIG. 1 is a block diagram of an exemplary computing device that may be used to monitor and/or control the operation of a machine.

FIG. 2 is block diagram of an exemplary monitoring system that includes a machine controller, and a facility controller.

FIG. 3 is a schematic view of a network that may be used with the monitoring system shown in FIG. 2.

FIG. 4 is a block diagram of an exemplary monitoring sensor that may be used with the network shown in FIG. 3.

FIG. 5 is a flowchart of an exemplary method that may be used to operate the network shown in FIG. 3.

### DETAILED DESCRIPTION OF THE INVENTION

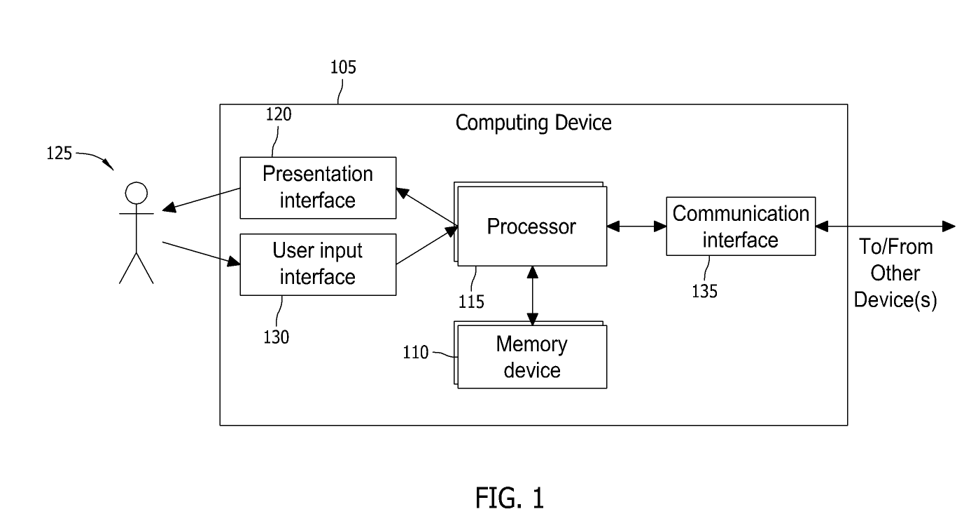

FIG. 1 is a block diagram of an exemplary computing device 105 that may be used to monitor and/or control the operation of a machine (not shown in FIG. 1). In some embodiments, computing device 105 is a data collection device. Computing device 105 includes a memory device 110 and a processor 115 operatively coupled to memory device 110 for executing instructions. In some embodiments, executable instructions are stored in memory device 110. Computing device 105 is configurable to perform one or more operations described herein by programming processor 115. For example, processor 115 may be programmed by encoding an operation as one or more executable instructions and providing the executable instructions in memory device 110. Processor 115 may include one or more processing units (e.g., in a multi-core configuration).

In the exemplary embodiment, memory device 110 is one or more devices that enable storage and retrieval of information such as executable instructions and/or other data. Memory device 110 may include one or more computer readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Further, as used herein, the terms “software” and “firmware” are interchangeable, and include any computer program stored in memory for execution by personal computers, workstations, clients and servers.

Memory device 110 may be configured to store operational measurements including, without limitation, vibration readings, field voltage and current readings, field reference setpoints, stator voltage and current readings, rotor speed readings, maintenance tasks, and/or any other type of data. In some embodiments, processor 115 removes or “purges” data from memory device 110 based on the age of the data. For example, processor 115 may overwrite previously recorded and stored data associated with a subsequent time and/or event. In addition, or alternatively, processor 115 may remove data that exceeds a predetermined time interval.

In some embodiments, computing device 105 includes a presentation interface 120 coupled to processor 115. Presentation interface 120 presents information, such as a user interface and/or an alarm, to a user 125. For example, presentation interface 120 may include a display adapter (not shown) that may be coupled to a display device (not shown), such as a cathode ray tube (CRT), a liquid crystal display (LCD), an organic LED (OLED) display, and/or an “electronic ink” display. In some embodiments, presentation interface 120 includes one or more display devices. In addition, or alternatively, presentation interface 120 may include an audio output device (not shown) (e.g., an audio adapter and/or a speaker) and/or a printer (not shown).

In some embodiments, computing device 105 includes a user input interface 130. In the exemplary embodiment, user input interface 130 is coupled to processor 115 and receives input from user 125. User input interface 130 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone). A single component, such as a touch screen, may function as both a display device of presentation interface 120 and user input interface 130.

A communication interface 135 is coupled to processor 115 and is configured to be coupled in communication with one or more other devices, such as a sensor or another computing device 105, and to perform input and output operations with respect to such devices. For example, communication interface 135 may include, without limitation, a wired network adapter, a wireless network adapter, a mobile telecommunications adapter, a serial communication adapter, and/or a parallel communication adapter. Communication interface 135 may receive data from and/or transmit data to one or more remote devices. For example, a communication interface 135 of one computing device 105 may transmit an alarm to the communication interface 135 of another computing device 105.

Presentation interface 120 and/or communication interface 135 are both capable of providing information suitable for use with the methods described herein (e.g., to user 125 or another device). Accordingly, presentation interface 120 and communication interface 135 may be referred to as output devices. Similarly, user input interface 130 and communication interface 135 are capable of receiving information suitable for use with the methods described herein and may be referred to as input devices.

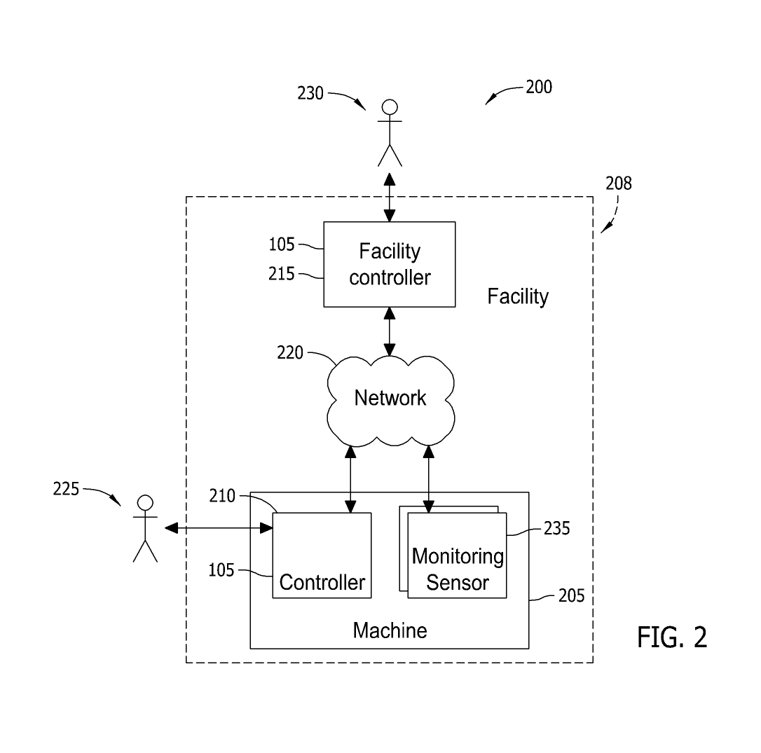

FIG. 2 is block diagram of an exemplary system 200 that may be used to monitor and/or operate a machine 205. In some embodiments, system 200 is a data acquisition system (DAS) and/or a supervisory control and data acquisition system (SCADA). Machine 205 may be any industrial equipment for any industrial process, including, without limitation, a chemical process reactor, a heat recovery steam generator, a steam turbine, a gas turbine, a switchyard circuit breaker, and a switchyard transformer. In the exemplary embodiment, machine 205 is a portion of a larger, integrated industrial facility 208. Facility 208 may include, without limitation, multiple machines 205. Also, in the exemplary embodiment, system 200 includes a machine controller 210 and a facility controller 215 coupled together in communication via a network 220.

In the exemplary embodiment, network 220 is a radio mesh network, or more specifically, a low-rate wireless mesh network (WMN). Network 220 may use the ZigBee® specification (ZigBee® is a registered trademark of the ZigBee Alliance, San Ramon, Calif., U.S.A), the WirelessHART™ standard based on the Highway Addressable Remote Transducer (HART®) protocol (WirelessHART™ is a trademark and HART® is a registered trademark of the HART Communication Foundation, Austin, Tex., U.S.A.), and/or any other communications standard based on the Institute of Electrical and Electronics Engineers (IEEE) standard 802.15.4™ (IEEE standard 802.15.4™ is a trademark of the IEEE Standards Association, Piscataway, N.J., U.S.A). Alternatively, network 220 may use any mesh network standard, specification and/or protocol, e.g., IEEE standard 802.16™, that enables system 200 to function as described herein.

Low-rate wireless network 220 transmits relatively small volumes of information, e.g., approximately, or less than, 250 Kilobits per second (Kbits/sec) and, e.g., at a frequency of approximately, or less than, 2.4 GHz. Embodiments of network 220 may include, without limitation, the Internet, a local area network (LAN), a wide area network (WAN), a wireless LAN (WLAN), and/or a virtual private network (VPN). While certain operations are described below with respect to particular computing devices 105, it is contemplated that any computing device 105 may perform one or more of the described operations. For example, controller 210 and controller 215 may perform all of the operations below.

Referring to FIGS. 1 and 2, in the exemplary embodiment, machine controller 210, and facility controller 215 are computing devices 105. Moreover, each computing device 105 is coupled to network 220 via communication interface 135. In an alternative embodiment, controller 210 is integrated with controller 215.

Controller 210 interacts with a first operator 225 (e.g., via user input interface 130 and/or presentation interface 120). For example, controller 210 may present information about machine 205, such as alarms, to operator 225. Facility controller 215 interacts with a second operator 230 (e.g., via user input interface 130 and/or presentation interface 120). For example, facility controller 215 may present alarms and/or maintenance tasks to second operator 230. As used herein, the term “operator” includes any person in any capacity associated with operating and maintaining facility 208, including, without limitation, shift operations personnel, maintenance technicians, and facility supervisors.

Machine 205 includes one or more monitoring sensors 235 in communication with network 220. In exemplary embodiments, monitoring sensors 235 collect operational measurements including, without limitation, vibration readings, field voltage and current readings, field reference setpoints, stator voltage and current readings, rotor speed readings, maintenance tasks, and/or any other type of data. Monitoring sensors 235 repeatedly (e.g., periodically, continuously, and/or upon request) transmit operational measurement readings at the current time. Additionally, monitoring sensors 235 may transmit a heartbeat signal to indicate an operational state (e.g., powered on, a fault condition, normal operating conditions, etc.). Such data is transmitted across network 220 and may be accessed by any device capable of accessing network 220 including, without limitation, desktop computers, laptop computers, and personal digital assistants (PDAs) (none shown). Transmissions may be selectively directed to any computing device 105 in communication with network 220, e.g., facility controller 215 or controller 210.

Facility 208 may include additional monitoring sensors (not shown) similar to monitoring sensors 235 that collect operational data measurements associated with the remainder of facility 208 including, without limitation, data from redundant machines 205 and facility environmental data, including, without limitation, local wind speed, local wind velocity, and local outside temperatures.

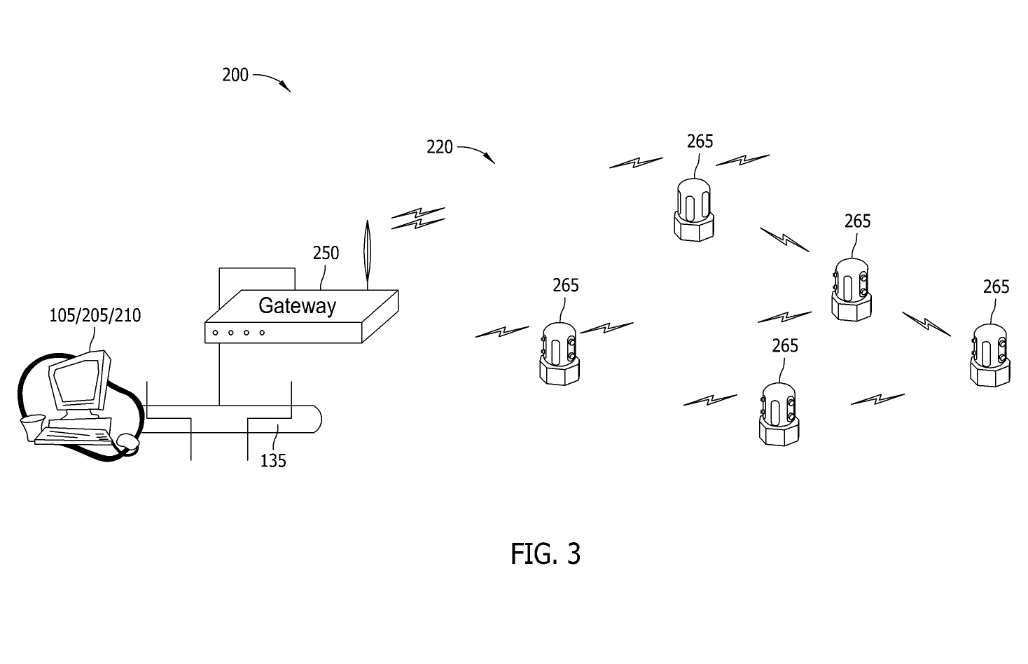

FIG. 3 is a schematic view of network 220. In the exemplary embodiment, network 220 includes a plurality of nodes 265 that are each individually addressable using a unique address. Each node 265 may function as a message originator, repeater, and/or message recipient. When performing the role of message originator, node 265 generates a data message that includes, without limitation, a destination address and a data payload. The destination address is a unique address of a pre-determined node. The data payload may include sensor measurement data, heartbeat messages, network/sensor configuration messages, control commands, and/or any data message. Data messages are relayed using network 220 from a message originator to a message recipient via repeaters, if necessary, capable of routing data messages to the destination address of the data message. Network 220 includes a gateway device 250, wherein device 250 is any gateway device that enables communication within network 220 as described herein (i.e., is a node within network 220), including, without limitation, a router, a modem, a USB adapter, and a switch. In the exemplary embodiment, each computing device 105 is coupled to network 220 via communication interface 135 that is coupled to gateway device 250. Alternatively, computing device 105 may be coupled to network 220 via communication interface 135, wherein interface 135 is a node on network 220.

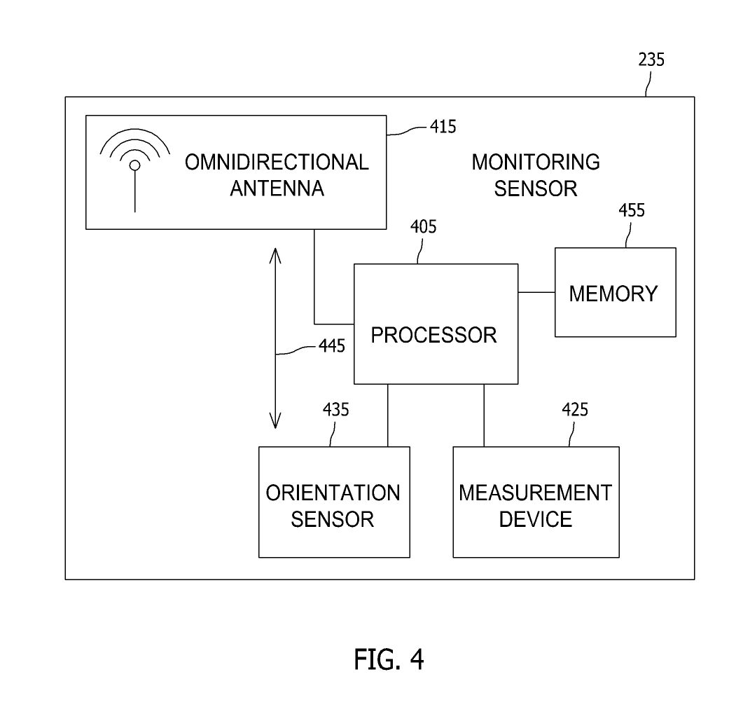

FIG. 4 is a block diagram of an exemplary monitoring sensor 235 for use with network 220. Each sensor 235 is a node 265 within network 220 and is capable of providing measurements via network 220. In the exemplary embodiment, monitoring sensor 235 includes a processor 405, similar to processor 115, coupled to an omnidirectional antenna 415. Alternatively, omnidirectional antenna 415 may be any antenna, e.g., a directional antenna, that enables system 200 to function as described herein. Processor 405 may be coupled to antenna 415 via a communications interface (not shown) that is capable of sending/receiving signals to and from both antenna 415 and processor 405. Processor 405 is programmed to receive measurement data and/or signals from a measurement device 425, generate a data message based on the measurement data/signal, and transmit the data message over network 220 via antenna 415.

In the exemplary embodiment, monitoring sensor 235 includes an orientation sensor 435. Orientation sensor 435 may be a gravity-vector-based sensor, a gyroscope, a multi-axis static accelerometer, and/or any sensor capable of determining orientation with respect to the Earth, a fixed point in 3-D space, a magnet, and/or another sensor. Orientation sensor 435 has a pre-determined orientation 445 with respect to omnidirectional antenna 415. In one embodiment, orientation 445 is based on design specifications of monitoring sensor 235. In another embodiment, orientation 445 is measured. Pre-determined orientation 445 is stored in a memory device 455, similar to memory device 110.

Pre-determined orientation 445 is used in combination with orientation data from orientation sensor 435 to determine the orientation of omnidirectional antenna 415. In one embodiment, processor 405 calculates the orientation of antenna 415 by processing orientation data from orientation sensor 435 in combination with pre-determined orientation 445. Processor 405 may be programmed to transmit the orientation of omnidirectional antenna 415 to a pre-determined computing device 105 via network 220. Alternatively, processor 405 may be programmed to transmit the orientation data from orientation sensor 435 and pre-determined orientation 445 to a pre-determined computing device 105 via network 220, wherein the pre-determined computing device 105 is configured to calculate the orientation of the omnidirectional antenna based on the orientation data and pre-determined orientation 445. A data message transmitted by processor 405 containing orientation information (e.g., the orientation of omnidirectional antenna 415 and/or orientation sensor 435) may be referred to as an “orientation message.”

A suitable computing device 105, e.g., controller 210 and/or 215, receives orientation messages from monitoring sensor 235. Computing device 105 compares and/or displays the orientations of two or more omnidirectional antennas 415 to facilitate aligning such antennas 415. For example, computing device 105 may display a 3-dimensional view of network 220 including the orientations of omnidirectional antennas 415. The display would enable an operator of computing device 105 to adjust the orientations of omnidirectional antennas 415 in network 220 to improve alignment of antennas 415 and therefore communications across network 220. More particularly, orientation information displayed by computing device 105 may be used to orient two or more antennas 415 in network 220 such that antennas 415 are oriented substantially parallel to each other. The display may include a graphical representation of each monitoring sensor 235 in network 220 with a visual indicator of the orientation of the omnidirectional antenna 415 of monitoring sensor 235. For example, an arrow in 3-dimensional space may represent the orientation. In addition, or alternatively, the display may contain the orientation of an antenna relative to its neighbors in network 220.

In one embodiment, computing device 105 stores the orientation of each omnidirectional antenna 415 such that a history of orientations is formed. Computing device 105 may use this history to detect if an omnidirectional antenna, and therefore monitoring sensor 235, has been moved. For example, computing device 105 may provide an alert via presentation interface 120 that monitoring sensor 235 has moved.

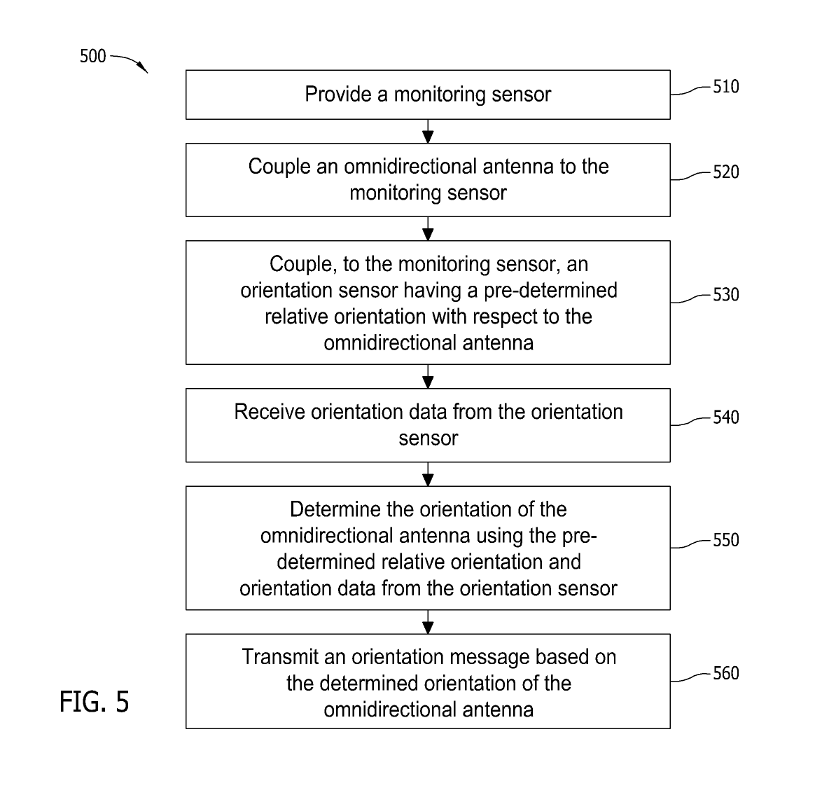

FIG. 5 is a flowchart 500 of an exemplary method for use in operating system 200. Initially, a monitoring sensor is provided 510 and an omnidirectional antenna is coupled 520 to the monitoring sensor. An orientation sensor is coupled 530 to the monitoring sensor with a pre-determined orientation with respect to the omnidirectional antenna. The monitoring sensor receives 540 orientation data from the orientation sensor. The monitoring sensor determines 550, e.g., using processor 405, the orientation of the omnidirectional antenna using the pre-determined relative orientation and orientation data transmitted from the orientation sensor. An orientation message is transmitted 560 by the monitoring sensor, via the omnidirectional antenna, based on the determined orientation of the omnidirectional antenna.

In contrast to known wireless mesh networks, the methods, systems, and apparatus described herein provide improved transmission of data. Specifically, in contrast to known wireless mesh networks, the monitoring methods, systems, and apparatus described herein facilitate uniformly orienting omnidirectional antennas used in wireless mesh network nodes. More specifically, in contrast to known wireless mesh networks, the monitoring methods, systems, and apparatus described herein enable the orientation of omnidirectional antennas to be determined in a wireless mesh network more effectively by using an orientation sensor. A multi-axis static accelerometer is coupled to a mesh network node with a pre-determined orientation with respect to the node antenna. The output of the accelerometer is used to relate the antenna orientation to the local gravity vector. The orientation of the antenna is calculated and transmitted to a computing device, perhaps as part of a routine message. The orientation is displayed within a software tool on the computing device, allowing a user to identify potential causes of poor communications or make improvements to the wireless mesh network. As omnidirectional antennas typically produce a toroidal radiation pattern, aligning each antenna in the wireless mesh network in a substantially parallel orientation will improve communications therethrough.

The methods and systems described herein provide an efficient and cost-effective means for improving communication between nodes in a wireless mesh network. As compared to known wireless mesh networks, the network and nodes described herein enable alignment of node antennas for improved communication efficiency. Results may include more reliable signals and faster data transmissions.

An exemplary technical effect of the methods, systems, and apparatus described herein includes at least one of (a) enabling determination of the orientation of an omnidirectional antenna in a network node used in a wireless mesh network; and (b) enabling the alignment or uniform orientation of omnidirectional antennas in a wireless mesh network, thereby increasing strength and reliability of wireless transmission between network nodes.

Described herein are exemplary embodiments of wireless mesh networks and monitoring systems that facilitate enabling transmission and receipt of monitoring data of systems and/or facilities. Specifically, the wireless mesh networks and monitoring systems described herein use omnidirectional antennas to facilitate extending such networks and monitoring systems. Also, specifically, the wireless mesh networks and monitoring systems described herein use orientation sensors to determine the orientation of the omnidirectional antennas, thereby facilitating substantially parallel alignment or orientation of the omnidirectional antennas.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

Some embodiments involve the Use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

While the invention has been described in terms of various specific embodiments, those skilled in the art will recognize that the invention can be practiced with modification within the spirit and scope of the claims.

What is claimed is:

1. A wireless mesh network comprising:
a first network node comprising a first antenna positioned in a first orientation, a first processor, and a first orientation sensor, said first processor programmed to determine the first orientation using said first orientation sensor and to transmit, using said first antenna, the first orientation to a computing device; and
a second network node comprising a second antenna positioned in a second orientation, a second processor, and a second orientation sensor, said second processor programmed to determine the second orientation using said second orientation sensor and to transmit, using said second antenna, the second orientation to said computing device for use in comparing the first orientation with the second orientation.

2. A wireless mesh network in accordance with claim 1, wherein said first network node further comprises at least one measurement device configured to measure at least one operational measurement.

3. A wireless mesh network in accordance with claim 1, wherein said first antenna has a pre-determined orientation with respect to said first orientation sensor.

4. A wireless mesh network in accordance with claim 3, wherein said first network node further comprises at least one memory device configured to store the pre-determined orientation.

5. A wireless mesh network in accordance with claim 4, wherein said first processor is programmed to determine the first orientation using the pre-determined orientation stored in said at least one memory device.

6. A wireless mesh network in accordance with claim 1, wherein said computing device is configured to store the first orientation for determining whether said first network node has been moved.

7. A wireless mesh network in accordance with claim 1, wherein said computing device is configured to display the first orientation and the second orientation.

8. A monitoring system comprising:
at least one monitoring sensor;
at least one computing device; and
a wireless mesh network comprising:
a first network node comprising a first antenna positioned in a first orientation, a first processor, and a first orientation sensor, said first processor programmed to determine the first orientation using said first orientation sensor and to transmit, using said first antenna, the first orientation to said at least one computing device; and
a second network node comprising a second antenna positioned in a second orientation, a second processor, and a second orientation sensor, said second processor programmed to determine the second orientation using said second orientation sensor and to transmit, using said second antenna, the second orientation to said at least one computing device for use in comparing the first orientation with the second orientation.

9. A monitoring system in accordance with claim 8, wherein said first network node further comprises at least one measurement device configured to measure at least one operational measurement.

10. A monitoring system in accordance with claim 8, wherein said first antenna has a pre-determined orientation with respect to said first orientation sensor.

11. A monitoring system in accordance with claim 10, wherein said first network node further comprises at least one memory device configured to store the pre-determined orientation.

12. A monitoring system in accordance with claim 11, wherein said first processor is programmed to determine the first orientation using the pre-determined orientation stored in said at least one memory device.

13. A monitoring system in accordance with claim 8, wherein said computing device is configured to store the first orientation for determining whether said first network node has been moved.

14. A monitoring system in accordance with claim 8, wherein said computing device is configured to display the first orientation and the second orientation.

15. A method of operating a network, said method comprising:
providing a first network node having a first antenna positioned in a first orientation, a first processor, and a first orientation sensor;
determining, using the first processor, the first orientation using the first orientation sensor;
providing a second network node having a second antenna positioned in a second orientation, a second processor, and a second orientation sensor;
determining, using the second processor, the second orientation using the second orientation sensor; and
comparing the first orientation with the second orientation.

16. A method in accordance with claim 15, wherein providing a first network node further comprises providing a first network node having at least one measurement device configured to measure at least one operational measurement.

17. A method in accordance with claim 15, further comprising transmitting, using the first antenna, the first orientation to a computing device.

18. A method in accordance with claim 17, further comprising transmitting, using the second antenna, the second orientation to the computing device.

19. A method in accordance with claim 18, wherein comparing the first orientation with the second orientation comprises comparing, using the computing device, the first orientation with the second orientation.

20. A method in accordance with claim 18, further comprising displaying, using the computing device, the first orientation and the second orientation.
